(19) United States
(12) Patent Application Publication
(10) Pub. No.: US 2008/0240770 A1
(43) Pub. Date: Oct. 2, 2008

(54) SEALING MEMBER, SEALING STRUCTURE INCORPORATED IN AN IMAGE FORMING UNIT, AND IMAGE FORMING APPARATUS THAT INCORPORATES THE IMAGE FORMING UNIT

(75) Inventor: Takanori MIMURA, Tokyo (JP)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: OKI DATA CORPORATION, Tokyo (JP)

(21) Appl. No.: 12/057,632

(22) Filed: Mar. 28, 2008

(30) Foreign Application Priority Data
Mar. 29, 2007 (JP) 2007-086663

(51) Int. Cl. G03G 15/08

(52) U.S. Cl. 399/103

(57) ABSTRACT

A sealing structure is incorporated in an image forming unit. A rotatable body is supported in a housing body. A sealing member extends in a longitudinal direction substantially parallel to the rotational axis of the rotatable body, providing a seal against the surface of the rotatable body. The sealing member includes a first widthwise end portion fixed to the housing body and a second widthwise end portion in contact with rotatable body, having a larger width at a longitudinally middle portion than at longitudinally end portions. The second widthwise end portion includes a widthwise free edge describing an arc such that the width is larger nearer the longitudinally middle portion. The sealing member may include longitudinally end portions and a longitudinally middle portion between the longitudinally end portions, the longitudinally middle portion having a constant width and the longitudinally end portions having a width smaller nearer the longitudinal ends.

### BACKGROUND OF THE INVENTION

1. Field of the Invention

The present invention relates to a sealing member, a sealing structure incorporated in an image forming unit, and an image forming apparatus that incorporates the image forming unit.

2. Description of the Related Art

Among conventional electrophotographic image forming apparatuses that use an electrophotographic image forming process are printers, copying machines, facsimile machines, and multi function printers (MFP). A charging roller charges the surface of a photoconductive drum uniformly. Then, an exposing unit illuminates the charged surface of the photoconductive drum in accordance with print data to form an electrostatic latent image. A developing roller supplies toner to the electrostatic latent image to develop the electrostatic latent image into a toner image. A transfer roller transfers the toner image onto a print medium. The toner image is then fused into a permanent image in a fixing unit. A cleaning unit is provided downstream of the transfer roller with respect to the direction of rotation of the photoconductive drum.

The charging roller, photoconductive drum, developing roller, and cleaning unit are supported on a chassis of the image forming apparatus.

A problem with a conventional printer is that a gap may exist between a photoconductive drum and a sealing member at a longitudinally middle portion of the photoconductive drum, so that toner may spill from the cleaning unit to cause a mess in the printer. This would cause soiling of print paper, soiling of the interior of the printer, and spoiled images.

### SUMMARY OF THE INVENTION

The present invention was made in view of the aforementioned drawbacks of conventional printers.

An object of the invention is to provide an image forming unit equipped with a sealing member that prevents a mess in the printer and soiling of print paper.

An object of the invention is to provide an image forming apparatus that provides a good image quality.

A sealing structure incorporated in an image forming unit includes a housing body, a rotatable body and a sealing member. The rotatable body is rotatably supported in the housing body. The sealing member provides a seal against the surface of the rotatable body. The sealing member extends in a longitudinal direction substantially parallel to the rotational axis of the rotatable body. The sealing member includes a first widthwise end portion fixed to the housing body and a second widthwise end portion in contact with rotatable body.

The sealing member has a larger width at a longitudinally middle portion than at longitudinally end portions. The second widthwise end portion having a widthwise free edge describing an arc such that the width is larger nearer the longitudinally middle portion.

The sealing member may include longitudinally end portions and a longitudinally middle portion between the longitudinally end portions, the longitudinally middle portion having a constant width and the longitudinally end portions having a width smaller nearer the longitudinal ends.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limiting the present invention, and wherein:

FIG. 1 illustrates a general configuration of a printer of a first embodiment;

FIG. 2 is a cross sectional side view illustrating an image forming unit of the first embodiment;

FIG. 3 is a perspective view of a pertinent portion of the image forming unit;

FIG. 4 is a front view of a sealing member;

FIG. 5 is an enlarged cross-sectional side view of the sealing member;

FIG. 6 illustrates a sealing member having a straight widthwise free edge;

FIG. 7 is a front view of a sealing member of a second embodiment;

FIG. 8 is a perspective view illustrating a pertinent portion of a base frame of the second embodiment; and

FIG. 9 is a top view of a pertinent portion of the base frame.

### DETAILED DESCRIPTION OF THE INVENTION

The invention will be described in detail in terms of a printer with reference to the accompanying drawings.

### First Embodiment

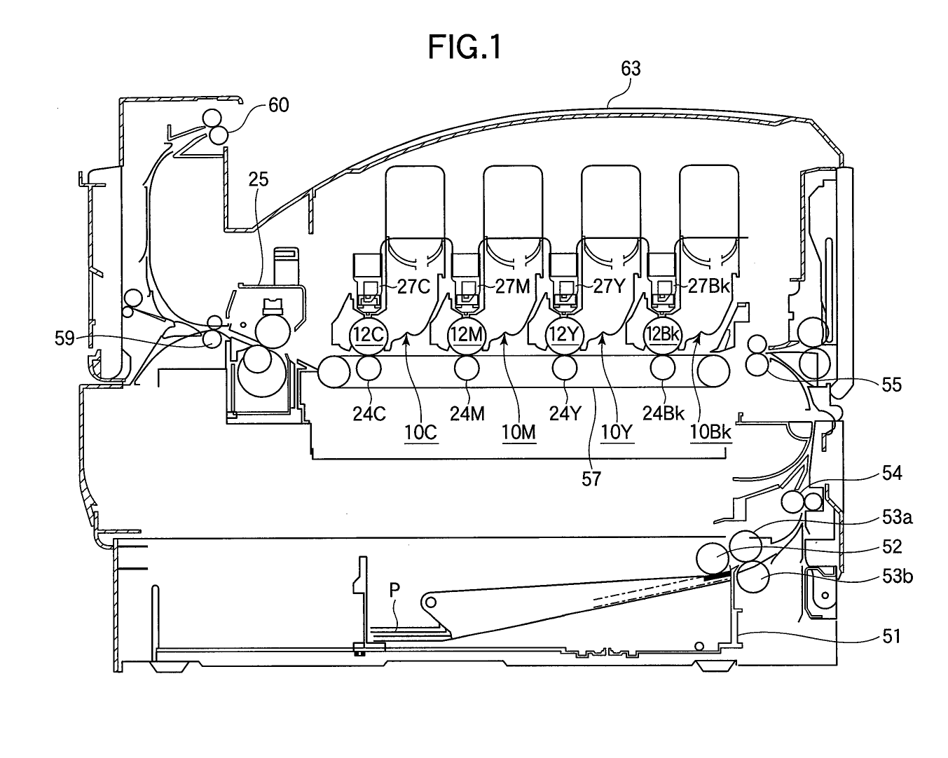

FIG. 1 illustrates a general configuration of a printer of a first embodiment.

Referring to FIG. 1, a paper cassette 51 is disposed at a lower portion of the printer, and holds a stack of print paper. A paper feeding mechanism is disposed adjacent the paper cassette 51, includes a hopping roller 52 and feeding rollers 53a and 53b, and feeds the print paper P on a sheet by sheet basis. The print paper P is further transported by transport rollers 54 and 55 and is then fed into a black image forming unit 10BK in timed relation with image formation in the black image forming unit 10BK. The print paper P is transported on a transport belt 57 through image forming units 10BK, 10Y, 10M, and 10C that form black, yellow, magenta, and cyan images, respectively. As the print paper P passes through transfer points defined between transfer rollers 24BK, 24Y, 24M, and 24C and photoconductive drums 12Bk, 12Y, 12M, and 12C, toner images of corresponding colors are transferred onto the print paper P in sequence one over the other in registration.

The print paper P is then advanced to a fixing unit 25 where the toner image is fused into a full color permanent image by heat and pressure. Then, the print paper P is further transported by a transport roller 59 from the fixing unit 25, and is then discharged by a discharge roller 60 onto an upper cover 63 in stacked relation.

The image forming units 10BK, 10Y, 10M, and 10C are detachably attached to the printer, and include the photoconductive drums 12Bk, 12Y, 12M, and 12C, respectively. Exposing units take the form of LED heads 27BK, 27Y, 27M, and 27C, and are disposed on the inner side of the upper cover 63 of the printer. The upper cover 63 is adapted to open and close. When the upper cover 63 is closed relative to the body of the printer, the exposing units 27BK, 27Y, 27M, and 27C are disposed over the corresponding photoconductive drums 12Bk, 12Y, 12M, and 12C and are ready to illuminate the charged surfaces of the corresponding photoconductive drums to form electrostatic latent images of corresponding colors. The exposing units take the form of an LED head. The image forming units 10BK, 10Y, 10M, and 10C, LED heads 27BK, 27Y, 27M, and 27C, the transfer rollers 24BK, 24Y, 24M, and 24C, and fixing unit 25 are major structural elements of the printer.

A description will be given of the image forming units 10BK, 10Y, 10M, and 10C. Each of the image forming units may be substantially identical; for simplicity only the operation of the image forming unit 10BK for forming black images will be described, it being understood that the other image forming units may work in a similar fashion.

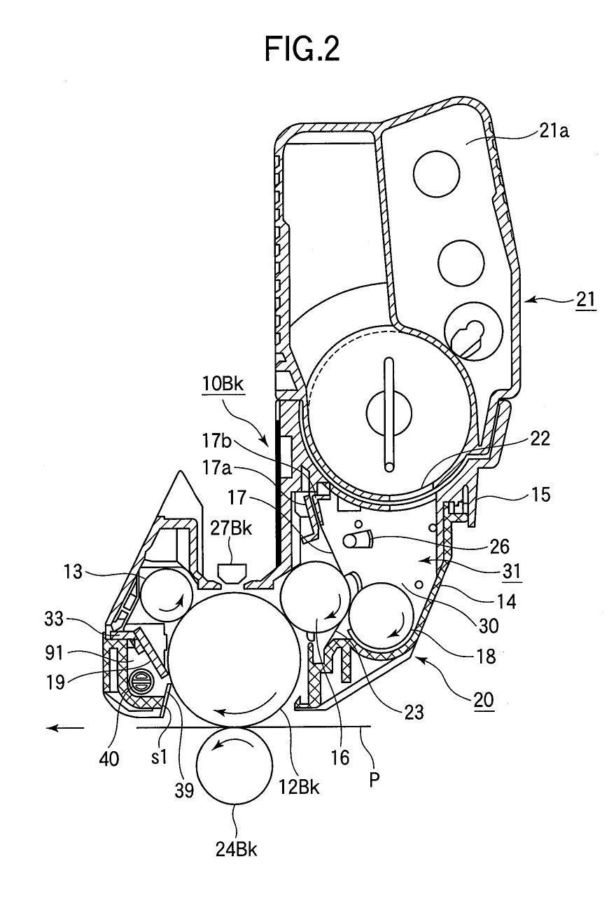

FIG. 2 is a cross sectional side view illustrating the image forming unit 10BK. The image forming unit 10BK includes a housing body or chassis 20 into which a toner cartridge 21 detachably attached. The toner cartridge 21 holds toner therein.

The photoconductive drum 12BK includes an aluminum core covered with a photoconductive base layer. The photoconductive base layer is covered with an organic photoconductive layer. A charging roller 13 includes a metal shaft covered with an electrically semi-conductive roll formed of, for example, epichlorohydrin rubber. A developing roller 16 includes a metal shaft covered with an electrically semi-conductive rubber such as silicone, and serves as a developer material bearing body. A toner supplying roller 18 includes a metal core covered with a foamed rubber material, and supplies the toner to the developing roller 16. A developing blade 17 has a free end portion in intimate contact with the circumferential surface of the developing roller 16, and forms a thin layer of toner on the developing roller 16. A cleaning blade 19 removes residual toner from the circumferential surface of the photoconductive drum 12BK. An agitator 26 is disposed over the toner supplying roller 18, and agitates the toner in a toner reservoir 30. The toner is supplied from the toner cartridge 21 into the toner reservoir 30. The developing roller 16, developing blade 19, toner supplying roller 18, and agitator 26 are all accommodated in the toner reservoir 30.

The chassis 20 includes a base frame 14 and a cover frame 15 that sits on the base frame 14.

The developing blade 17 is held between supports 17a and 17b in sandwiched relation, and is fixed to the cover frame 15 by means of bolts (not shown). The cleaning blade 19 is firmly bonded to a bracket 33 by means of an adhesive such as hot melt. The bracket 33 is covered with, for example, urethane rubber. The bracket 33 is attached to the base frame 14. A waste toner transport member 40 takes the form of a spiral or a coil spring, and transports the waste toner removed by the cleaning blade from the photoconductive drum 12BK. The waste toner transport member 40 is disposed in a toner collecting chamber 91 defined between the cleaning blade 19 and base frame 14.

The photoconductive drum 12BK rotates in contact with the charging roller 13, developing roller 16, and cleaning blade 19. The developing roller 16 rotates in contact with the developing blade 17 and toner supplying roller 18. The photoconductive drum 12BK, charging roller 13, developing roller 16, and toner supplying roller 18 are driven in rotation by a drive source (not shown) in directions shown by arrows, and receives electric power from corresponding power supplies (not shown), respectively.

The photoconductive drum 12BK and charging roller 13 are rotatably supported on two opposing side frames. The base frame 14 and cover frame 15 are formed of a resin material having a high hardness and a high heat resistance, for example, denatured PPE.

A sealing member 39 is mounted on the base frame 14 at a position downstream of the transfer roller 24BK with respect to rotation of the photoconductive drum 12BK, and upstream of the cleaning blade 19. The sealing member 39 is mounted to a mounting surface S1 surrounding an opening of the base frame 14 such that a free end portion of the sealing member 39 is in pressure contact with the circumferential surface of the photoconductive drum 12BK. The free end portion of the sealing member 39 may include a widthwise free edge E2 (FIG. 4) of the sealing member 39 and an area in the vicinity of the widthwise free edge E2. The sealing member 39 closes a gap between the photoconductive drum 12BK and the base frame 14, and provides a seal against the circumferential surface of the photoconductive drum 12BK. The photoconductive drum 12BK rotates in contact with the sealing member 39.

A sealing member 23 is disposed downstream of the toner supplying roller 18 with respect to rotation of the developing roller 16 and upstream of the photoconductive drum 12BK, and has an free end portion in contact with the developing roller 16 to seal the gap between the developing roller 16 and the base frame 14. The free end portion of the sealing member 23 may include a widthwise free edge of the sealing member 23 and an area in the vicinity of the widthwise edge. The developing roller 16 rotates in contact with the sealing member 23.

The operation of the image forming unit 10BK will be described.

When a drive motor rotates and the power supplies are turned on, the developing roller 16 and toner supplying roller 18 rotate in the directions shown by arrows to supply the toner from the toner supplying roller 18 to the developing roller 16. As the developing roller 16 rotates, the toner on the developing roller 16 advances to the developing blade 17, which in turn presses the toner against the developing roller 16 to form a thin layer of toner on the developing roller 16. As the developing roller 16 further rotates, the thin layer of toner is brought into contact with the electrostatic latent image on the photoconductive drum 10BK, thereby forming a toner image.

Some of the toner may remain on the photoconductive drum 12BK after transfer of the toner image onto the print paper P. The cleaning blade 19 removes residual toner from the photoconductive drum 12BK. The residual toner removed from the photoconductive drum 12BK is collected into the toner collecting chamber 91. The toner in the toner collecting chamber 91 is transported into a waste toner chamber 21a by a waste toner transporting member 40. The free end portion of the sealing member 39 remains in intimate contact with the circumferential drum 12BK, and provides a seal between the toner collecting chamber 91 and the photoconductive drum 12BK.

The mounting of the sealing member 39 will be described.

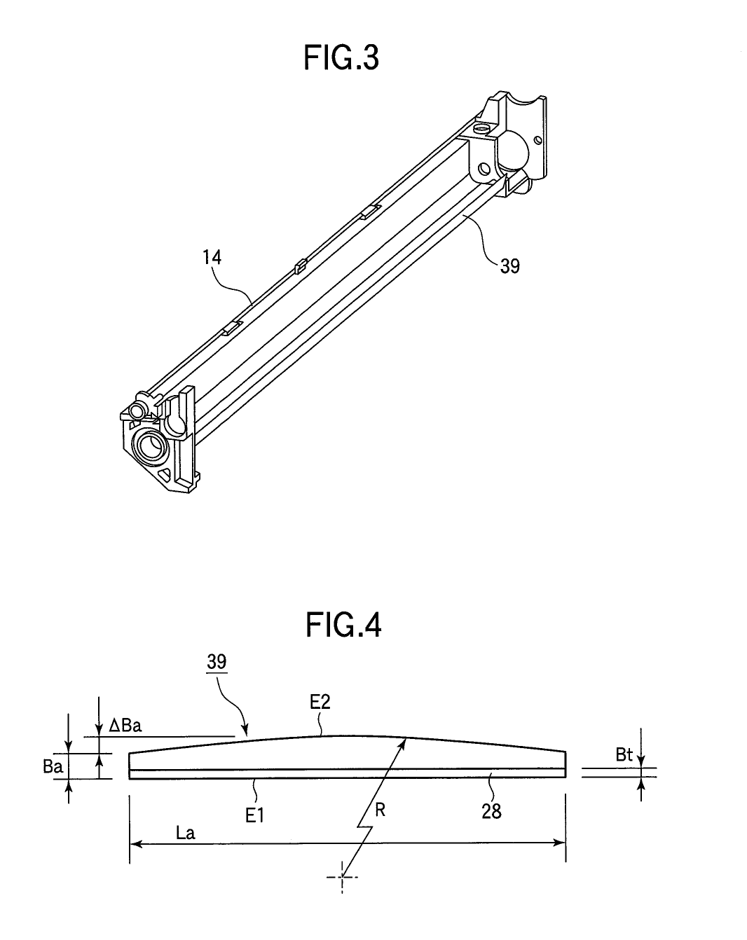

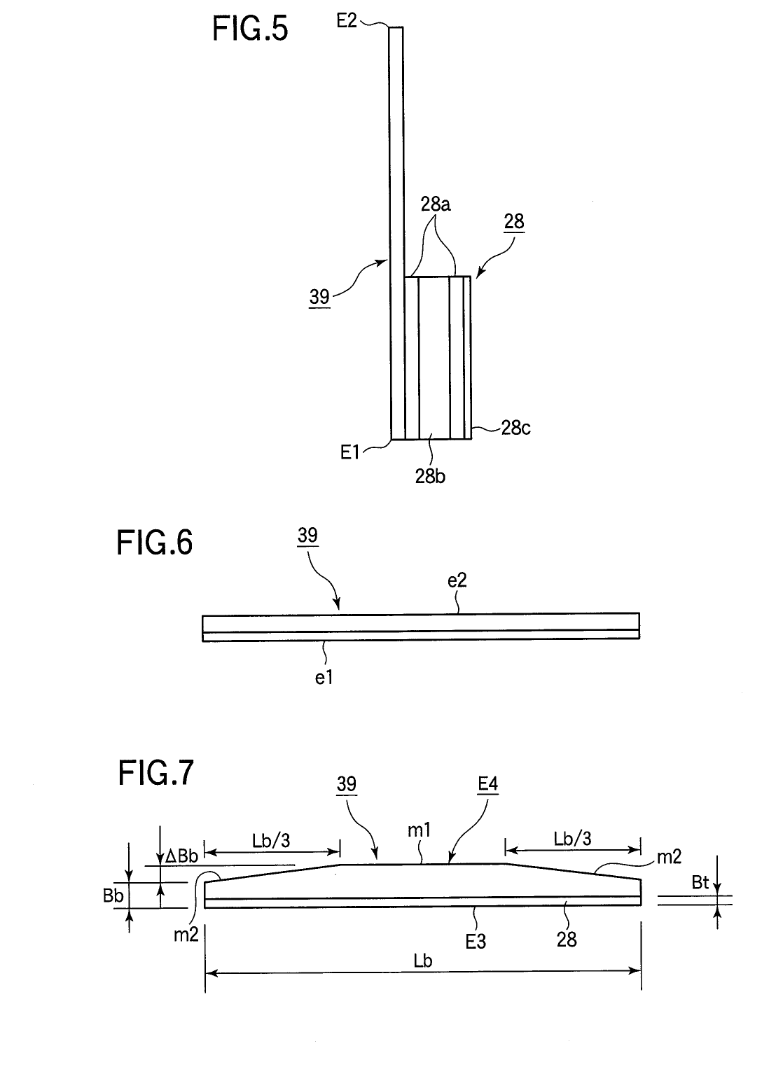

FIG. 3 is a perspective view of a pertinent portion of the image forming unit of the first embodiment. FIG. 4 is a front view of the sealing member 39. FIG. 5 is an enlarged cross-sectional side view of the sealing member 39.

The sealing member 39 is formed of a film-shaped insulating material, for example, a urethane film which is a thermoplastic resin, so that the sealing member 39 will not cause damage to or wear of the photoconductive drum 12Bk, and so that the sealing member 39 is not sensitive to changes in environmental conditions. The sealing member 39 is bonded to the mounting surface S1 (FIG. 2) surrounding an opening of the base frame 14 as shown in FIG. 3. When the photoconductive drum 12BK rotates, the sealing member 39 will not disturb the rotation of the photoconductive drum 12BK or put any load on the photoconductive drum 12BK.

Referring to FIG. 4, the sealing member 39 is in the shape of a belt extending in a direction substantially parallel to the rotational axis of the photoconductive drum 12BK. The sealing member 39 is mounted to the base frame 14 such that a bonding portion 28 including a widthwise end portion having a widthwise edge E1 is bonded to the mounting surface S1 and another widthwise end portion having a widthwise free edge E2 abuts the photoconductive drum 12BK. A very narrow bonding portion 28 extends in a longitudinal direction of the sealing member 39, and is bonded to the base frame 14. The widthwise free edge E2 describes an arc or curvature extending substantially in a longitudinal direction such that the sealing member 39 has a smaller width nearer the longitudinal end portions.

Referring to FIG. 5, the bonding portion 28 includes a stacked construction where a thin plate 28b sandwiched between two double side adhesive tapes 28a. The stacked structure is then sandwiched between the sealing member 39 and a releasing paper 28c. The releasing paper 28c is removed prior to attachment of the sealing member 39 to the mounting surface S1.

The thin plate 28b is formed of a highly rigid material (e.g., stainless steel SUS, or polyethylene resin). The high rigidity of the thin plate 28b prevents the sealing member 39 from being wrinkled when the sealing member 39 is bonded to the base frame 14, facilitating mounting of the sealing member 39 to the base frame 14.

The sealing member 39 has a length of La=325 mm, a height of Ba=6.5 mm at longitudinal ends, and a width difference ΔBa=0.5 mm between the longitudinal middle portion and the longitudinal ends. The width of the double side adhesive tape 28a and thin plate 28b is Bt=3 mm, and the thickness of the sealing member 39 is 0.2 mm. The radius of curvature of the widthwise free edge E2 is such that the width difference is ΔBa=0.5 mm.

The sealing member 39 is designed to be bonded to the mounting surface S1 by means of the double side adhesive tape 28a (FIG. 5) before the image forming unit 10BK (FIG. 2) is attached to the printer. When the image forming unit 10BK is attached to the printer after the sealing member 39 has been bonded to the mounting surface S1, the widthwise free edge E2 of the sealing member 39 interferes with the photoconductive drum 12BK, and the sealing member 39 resiliently deforms so that a reaction force acts on the mounting force S1.

FIG. 6 illustrates a conventional sealing member 39A having a straight widthwise free edge e2 as opposed to that of FIG. 4.

The widthwise free end e2 and widthwise fixed end e1 extend straight and parallel to each other. If the widthwise free edge e2 extends merely straight, the following problem arises.

When the widthwise free end e2 of the sealing member 39A interferes with the photoconductive drum 12BK, the reaction force acts on the mounting force S1 causing the mounting surface S1 to describe an arc, i.e., a recessed surface. This deformation of the mounting surface S1 causes variation of pressing force of the sealing member 39A against the photoconductive drum 12BK along the length of the sealing member 39A. In other words, the pressing force is smaller at the longitudinal middle portion of the photoconductive drum 12BK than at longitudinal ends. As a result, there may be a gap between the widthwise free edge e2 of the sealing member 39A and the photoconductive drum 12BK at the longitudinal middle portion of the photoconductive drum 12BK.

In the first embodiment, the widthwise free edge E2 is shaped to describe an arc. The arcuate shape of the widthwise free edge E2 prevents the pressing force of the sealing member 39 from being smaller at the longitudinally middle portion of the photoconductive drum 12BK than at the longitudinal end portions of the photoconductive drum 12BK. In other words, the pressing force of the sealing member 39 may be substantially uniform across the length of the photoconductive drum 12BK, and no gap is developed between the sealing member 39 and the longitudinally middle portion of the photoconductive drum 12BK.

Thus, the toner will no longer spill from the cleaning unit and cause a mess in the printer. This will prevent spoiled images and soiling of print paper P. While the first embodiment has been described in terms of the sealing member 39 that provides a seal against the photoconductive drum, the invention may also be applicable to the sealing member 23 (FIG. 2) that provides a seal against the developing roller 16. The operation and configuration are the same as for the sealing member 39 except that the developing roller is used in place of the photoconductive drum, and therefore the detailed description is omitted.

### Second Embodiment

Forming the curved widthwise free edge E2 of the sealing member 39 of the first embodiment requires a mold of high cost. A second embodiment is directed to manufacturing of the sealing member 39 at low cost. Elements similar to those of the first embodiment have been given the same reference numerals and their description is omitted. It is assumed that the same structure as the first embodiment provides the same advantages.

FIG. 7 is a front view of a sealing member 39 of a second embodiment.

The sealing member 39 may include a straight widthwise edge E3 and a free end portion having a widthwise free edge E4 and an area in the vicinity of the widthwise free edge E4. The sealing member 39 is generally trapezoidal such that the widthwise free edge E4 includes longitudinal end portions m2 and m3 and a middle portion m1 between the longitudinal end portions m2 and m3. The middle portion m1 extends substantially parallel to the widthwise edge E3. The sealing member 39 has a constant width across the middle portion m1 while the longitudinal end portions m2 and m3 have a linearly decreasing width nearer the longitudinal ends.

The sealing member 39 has a length of La=325 mm, a height of Bb=6.5 mm at the longitudinal ends, and a difference ΔBb=0.5 mm in height between the longitudinally middle portion and the longitudinal ends. The width of the double side adhesive tape 28a and thin plate 28b is Bt=3 mm, and the thickness of the sealing member 39 is 0.2 mm.

The free end portion of the sealing member 39 is in intimate contact with the circumferential drum 12BK, and provides a seal between the toner collecting chamber 91 and the photoconductive drum 12BK. The pressing force of the sealing member 39 against the photoconductive drum 12BK may be substantially uniform across the full length of the photoconductive drum 12BK (FIG. 2), so that no gap is developed between the sealing member 39 and the photoconductive drum 12BK at the longitudinally middle portion of the photoconductive drum 12BK.

Because the widthwise free edge E4 is a combination of straight sides m1, m2, and m3, a die with a Thomson blade may be used for stamping the sealing member 39. This implies that the cost of a die may be low, and therefore the cost of the sealing member 39 may be low.

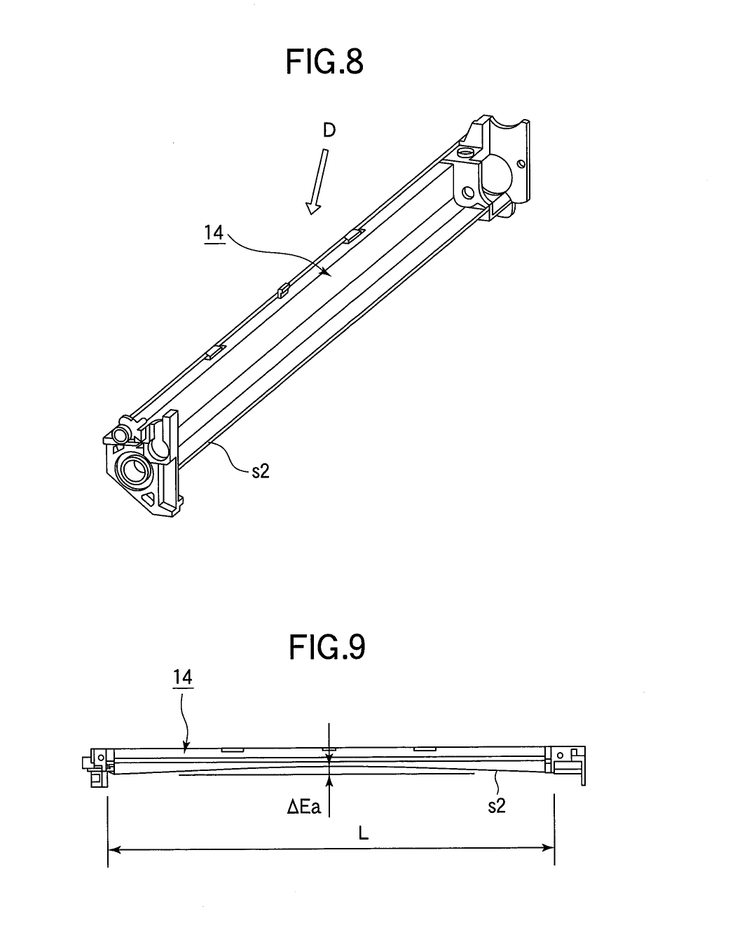

FIG. 8 is a perspective view illustrating a pertinent portion of a base frame 14 of the second embodiment. FIG. 9 is a top view of a pertinent portion of the base frame 14.

The base frame 14 has a mounting surface S2 to which the sealing member 39 (FIG. 7) is bonded. The mounting surface S2 extends to describe an arc such that the distance between the mounting surface S2 and the photoconductive drum 12BK is longer nearer a longitudinally middle portion of the photoconductive drum 12BK.

This is advantageous when the base frame 14 is to be formed by injection molding. In other words, warpage of the mounting surface S2 after molding the base frame 14 may be controlled by carefully selecting the molding conditions such as temperature and time. Alternatively, warpage of the mounting surface S2 of the base frame 14 may be implemented by using a mold having a curved surface complementary to a curved mounting surface S2 of the base frame 14.

The mounting surface S2 has a length L=325 mm and the difference in the depth of the curved mounting surface S2 between the longitudinally middle portion and the longitudinal ends is Δ Ea=0.5 mm. The sealing member 39 has a bonding portion via which the sealing member 39 is firmly mounted to the base frame 14. The bonding portion is of the same construction as that (28) shown in FIG. 5 and the detailed description is omitted.

When the image forming unit 10BK is assembled or attached to a printer, if the base frame 14 is pushed toward the photoconductive drum 12BK, the base frame 14 may deform in such a way that the longitudinally middle portion of the base frame 14 deforms toward the photoconductive drum 12BK to touch the photoconductive drum 14. If the photoconductive drum 10BK is scratched by the base frame 14, white dots or streaks may appear on printed color images at intervals of rotation of the photoconductive drum 10BK.

Therefore, as described above, the mounting surface S2 has a curvature such that the mounting surface S2 is farther away from the photoconductive drum 10BK at the longitudinally middle portion than at the longitudinal ends. Thus, the mounting surface S2 will not touch the photoconductive drum 12BK. This minimizes the chance of white streaks or white dots appearing in printed images, thereby improving print quality.

While the second embodiment has been described in terms of the sealing member 39 that provides a seal against the photoconductive drum 14, the invention may also be applicable to a sealing member 23 (FIG. 2) that provides a seal against the developing roller 16. The operation and configuration are the same as for the sealing member 39 except that a developing roller 16 is used in place of a photoconductive drum 14, and therefore the detailed description is omitted.

While the present invention has been described with respect to a printer, the present invention may also be applied to copying machines, facsimile machines, and multi function printers.

The invention being thus described, it will be obvious that the same may be varied in many ways. Such variations are not to be regarded as a departure from the spirit and scope of the invention, and all such modifications as would be obvious to one skilled in the art intended to be included within the scope of the following claims.

What is claimed is:

1. A sealing structure incorporated in an image forming unit, comprising:
a housing body;
a rotatable body rotatably supported in the housing body; and
a sealing member that provides a seal against a surface of the rotatable body, the sealing member extending in a longitudinal direction substantially parallel to a rotational axis of the rotatable body, the sealing member including a first widthwise end portion fixed to the housing body and a second widthwise end portion in contact with rotatable body, wherein the sealing member has a larger width at a longitudinally middle portion than at longitudinally end portions.

2. The sealing structure according to claim 1, wherein the second widthwise end portion includes a widthwise free edge describing an arc such that the width is larger nearer the longitudinally middle portion.

3. The sealing structure according to claim 1, wherein the sealing member includes longitudinally end portions and a longitudinally middle portion between the longitudinally end portions, the longitudinally middle portion having a constant width and the longitudinally end portions having a width smaller nearer the longitudinal ends.

4. The sealing structure according to claim 1, wherein the sealing member is mounted to a mounting surface of the housing body, the mounting surface extending in a longitudinal direction substantially parallel to the rotatable body and being farther away from the rotatable body at a longitudinally middle portion than at longitudinal ends.

5. The sealing structure according to claim 1, wherein the rotatable body is a photoconductive drum of the image forming unit.

6. The sealing structure according to claim 1, wherein the rotatable body is a developing roller of the image forming unit.

7. A sealing member extending in a longitudinal direction along a rotatable body rotatably supported in a housing body, the sealing member comprising:
a first widthwise end portion fixed to the housing body; and
a second widthwise end portion in contact with the rotatable body to provide a seal against the rotatable body; and
wherein the sealing member has a larger width at a longitudinally middle portion than at longitudinally ends.

8. An image forming apparatus that incorporates the sealing structure according to claim 1.

9. An image forming apparatus that incorporates the sealing structure according to claim 2.

10. An image forming apparatus that incorporates the sealing structure according to claim 3.

11. An image forming apparatus that incorporates the sealing structure according to claim 4.

12. An image forming apparatus that incorporates the sealing structure according to claim 5.

13. An image forming apparatus that incorporates the sealing structure according to claim 6.

14. An image forming apparatus that incorporates the sealing member according to claim 7.
